(19) United States
(12) Patent Application Publication
(10) Pub. No.: US 2022/0120578 A1
(43) Pub. Date: Apr. 21, 2022

(54) ROUTE EVALUATION METHOD AND APPARATUS, ELECTRONIC DEVICE AND STORAGE MEDIUM

(71) Applicant: Beijing Baidu Netcom Science Technology Co., Ltd., Beijing (CN)

(72) Inventor: Weimin LIU, Beijing (CN)

(73) Assignee: Beijing Baidu Netcom Science Technology Co., Ltd., Beijing (CN)

(21) Appl. No.: 17/568,059

(22) Filed: Jan. 4, 2022

(30) Foreign Application Priority Data
Mar. 25, 2021 (CN) 202110321085.3

(51) Int. Cl. G01C 21/34

(52) U.S. Cl. CPC G01C 21/3484; G01C 21/3407

(57) ABSTRACT

Provided are a route evaluation method, an electronic device and a storage medium. The method includes: acquiring target truth value data on user behaviors between a first to-be-evaluated location and a second to-be-evaluated location and collected by a route planning client, where at least one to-be-evaluated route is included between the first to-be-evaluated location and the second to-be-evaluated location; determining a target reference route between the first to-be-evaluated location and the second to-be-evaluated location according to the target truth value data on user behaviors; and evaluating the at least one to-be-evaluated route according to the target reference route. Therefore, the labor cost of route evaluation can be reduced and the accuracy and efficiency of the route evaluation can be improved.

### CROSS-REFERENCE TO RELATED APPLICATION(S)

This application claims priority to Chinese Patent Application No. 202110321085.3 filed Mar. 25, 2021, the disclosure of which is incorporated herein by reference in its entirety.

### TECHNICAL FIELD

The present disclosure relates to the field of data processing, in particular, the fields of big data, intelligent transportation, cloud computing and the like.

### BACKGROUND

With the requirement of location services and the Internet of Things for location information, a navigation technology has been rapidly developed and widely applied. The navigation technology can perform positioning and route planning by use of location-related parameters in the real world to safely, accurately and reasonably guide the trips of users. In the field of navigation, a trip route planned for a user needs to be reasonably adjusted according to actual trip data to satisfy the trip requirement of the user and the interests of the company providing public transportation means. Therefore, the evaluation of the trip route of the user by use of computer means and big data can not only demonstrate the advantages and disadvantages of the trip route from multiple perspectives but also reasonably adjust the trip route of the user according to an evaluation result, which facilitates the adjustment of line operation planning, further improves the intelligence of intelligent transportation, and enables residents to be convenient to travel and satisfied with trips.

### SUMMARY

Embodiments of the present disclosure provide a route evaluation method and apparatus, an electronic device and a storage medium, which can reduce the labor cost of route evaluation and improve the accuracy and efficiency of the route evaluation.

In a first aspect, an embodiment of the present disclosure provides a route evaluation method. The method includes steps described below.

Target truth value data on user behaviors between a first to-be-evaluated location and a second to-be-evaluated location and collected by a route planning client is acquired, where at least one to-be-evaluated route is included between the first to-be-evaluated location and the second to-be-evaluated location.

A target reference route between the first to-be-evaluated location and the second to-be-evaluated location is determined according to the target truth value data on user behaviors.

The at least one to-be-evaluated route is evaluated according to the target reference route.

In a second aspect, an embodiment of the present disclosure provides an electronic device. The device includes at least one processor and a memory communicatively connected to the at least one processor.

The memory stores instructions executable by the at least one processor to enable the at least one processor to perform the route evaluation method provided by the embodiment in the first aspect.

In a third aspect, an embodiment of the present disclosure provides a non-transitory computer-readable storage medium storing computer instructions for causing a computer to perform the route evaluation method provided by the embodiment in the first aspect.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the present solution and not to limit the present disclosure. In the drawings:

FIG. 1 is a flowchart of a route evaluation method according to an embodiment of the present disclosure;

FIG. 2 is a flowchart of a route evaluation method according to an embodiment of the present disclosure;

FIG. 3 is a structure diagram of a route evaluation apparatus according to an embodiment of the present disclosure; and

FIG. 4 is a structure diagram of an electronic device for implementing a route evaluation method according to an embodiment of the present disclosure.

### DETAILED DESCRIPTION

Example embodiments of the present disclosure, including details of embodiments of the present disclosure, are described hereinafter in conjunction with the drawings to facilitate understanding. The example embodiments are illustrative only. Therefore, it is to be understood by those of ordinary skill in the art that various changes and modifications may be made to the embodiments described herein without departing from the scope and spirit of the present disclosure. Similarly, description of well-known functions and constructions is omitted hereinafter for clarity and conciseness.

At present, when a route planned by navigation software is evaluated, evaluation needs to be performed based on route-related truth value data. For example, when a bus route planning function is evaluated, each planned bus route needs to be evaluated based on a real optimal route between two stations. In the related art, during route evaluation, truth value data for evaluating routes is generally acquired by two schemes described below. (1) The truth value data is acquired through manual drive tests. For example, a public transport vehicle such as a bus or a subway or a private vehicle is ridden so that data is recorded through on-the-spot investigation and an optimal route between two locations is determined based on the recorded data. (2) The truth value data is investigated through user interviews. For example, questionnaires are delivered so that users evaluate the optimal route between the two locations.

However, the above scheme (1) requires a large amount of labor, resulting in low efficiency of route evaluation. The truth value data in scheme (2) tends to be user-subjective and the evaluation based on the truth value data has low accuracy. That is, an existing route evaluation method has the problems of a high labor cost, low efficiency, low accuracy and the like.

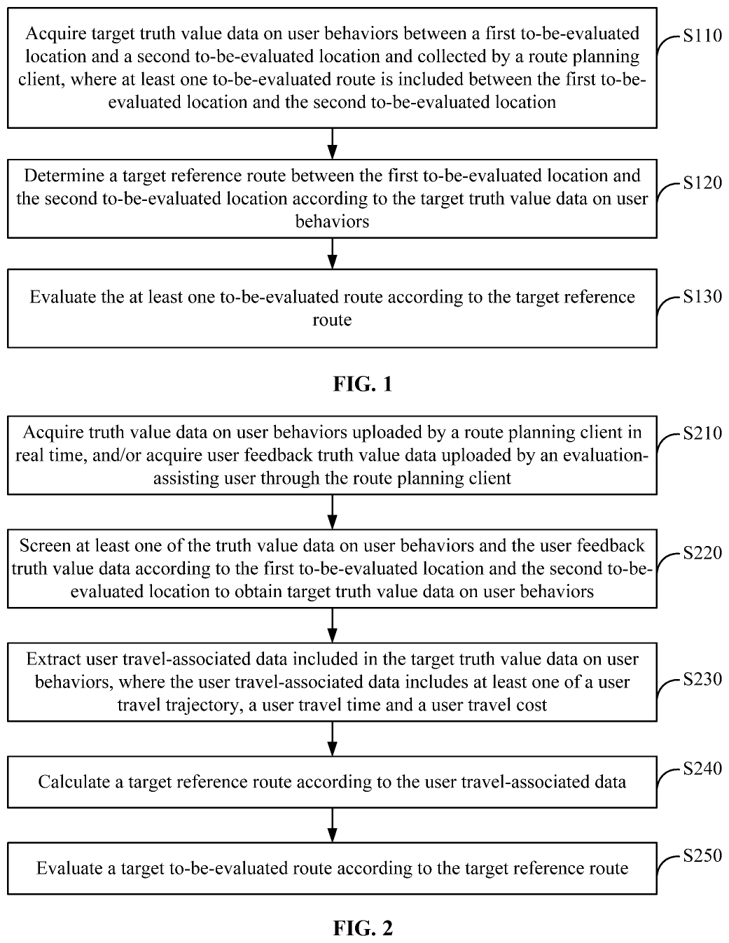

In one example, FIG. 1 is a flowchart of a route evaluation method according to an embodiment of the present disclosure. This embodiment is applicable to the case where route evaluation is performed according to target truth value data on user behaviors between two locations and collected by a route planning client. The method may be performed by a route evaluation apparatus which may be implemented by software and/or hardware and generally be integrated into an electronic device. The electronic device may exchange data with the route planning client and may be a terminal device, a server device or the like. Accordingly, as shown in FIG. 1, the method includes operations described below.

In S110, target truth value data on user behaviors between a first to-be-evaluated location and a second to-be-evaluated location and collected by the route planning client is acquired, where at least one to-be-evaluated route is included between the first to-be-evaluated location and the second to-be-evaluated location.

The route planning client may be any type of client that has a route planning function or can acquire route-related data, such as a map client or a taxi client. The specific type of the route planning client is not limited in the embodiment of the present disclosure. The first to-be-evaluated location and the second to-be-evaluated location may be two actual geographical locations. For example, the first to-be-evaluated location may be a start point of a route and the second to-be-evaluated location may be an end point of the route. Alternatively, the second to-be-evaluated location may be the start point of the route and the first to-be-evaluated location may be the end point of the route. The to-be-evaluated route may be included between the first to-be-evaluated location and the second to-be-evaluated location. Each to-be-evaluated route may be a route planned by the route planning client or may be a known planned route acquired in any manner, such as a route pre-planned for a public transport system such as a bus or a subway. The to-be-evaluated route may be a route to which any type of vehicle or an individual takes reference, such as a planned route for a public transport vehicle such as the bus or the subway, a planned route for an individual vehicle such as a taxi, a private car, an electric vehicle or a bicycle, or a walking route of a user. A manner for acquiring the to-be-evaluated route and a route type thereof are not limited in the embodiments of the present disclosure. The target truth value data on user behaviors may be truth value data on user behaviors generated between the first to-be-evaluated location and the second to-be-evaluated location. A truth value, that is, a true value, is an actual value objectively existing through measurement under certain conditions. Accordingly, the truth value data on user behaviors is data on true values for recording the user behaviors, such as the movement trajectory, positioning, movement speed, pause time, and behavioral habits of the user between the two locations. Any data that can reflect a behavior type of the user between the two locations may be regarded as the truth value data on user behaviors. The type and content of the truth value data on user behaviors and the target truth value data on user behaviors are not limited in the embodiment of the present disclosure.

In the embodiment of the present disclosure, the electronic device that performs the route evaluation may exchange data with the route planning client and may be the terminal device or the server device, such as a cloud computing server. The type of the electronic device that performs the route evaluation method is not limited in the embodiment of the present disclosure. Accordingly, the electronic device that performs the route evaluation method (hereinafter referred to as the electronic device) may interact with the route planning client to acquire the target truth value data on user behaviors between the first to-be-evaluated location and the second to-be-evaluated location and collected by the route planning client. The target truth value data on user behaviors reflects behavior situations of active users between the first to-be-evaluated location and the second to-be-evaluated location, such as the movement trajectory, movement speed, pause location and pause time at each pause location of the user between the first to-be-evaluated location and the second to-be-evaluated location.

It is to be understood that before performing the route evaluation, the electronic device may locally store all to-be-evaluated routes included between the first to-be-evaluated location and the second to-be-evaluated location. The to-be-evaluated routes may be the routes generated by the route planning client or may be planned routes imported in batch, which is not limited in the embodiment of the present disclosure.

In S120, a target reference route between the first to-be-evaluated location and the second to-be-evaluated location is determined according to the target truth value data on user behaviors.

The target reference route may be an optimal route between the first to-be-evaluated location and the second to-be-evaluated location. In an embodiment, the target reference route may include, but is not limited to, at least one of a shortest distance route, a shortest time route, a lowest cost route and a comprehensive optimal route. The comprehensive optimal route may be an optimal route determined in conjunction with multiple factors, such as a distance, a time and a cost, that affect the quality of the route evaluation, for example, a route with a shortest distance, a shortest time and a lowest cost or a route with the shortest distance, the shortest time and a medium cost. The type of the target reference route is not limited in the embodiments of the present disclosure.

Accordingly, after acquiring the target truth value data on user behaviors, the electronic device may perform data processing and computing using the target truth value data on user behaviors to calculate the target reference route between the first to-be-evaluated location and the second to-be-evaluated location according to the target truth value data on user behaviors.

It is to be understood that the target reference route may be the same as one to-be-evaluated route or may be different from any one to-be-evaluated route. The number of the target reference route may be at least one.

In S130, the at least one to-be-evaluated route is evaluated according to the target reference route.

Accordingly, after the target reference route between the first to-be-evaluated location and the second to-be-evaluated location is obtained, all the to-be-evaluated routes between the first to-be-evaluated location and the second to-be-evaluated location may be evaluated using the target reference route.

Exemplarily, when the target reference route is the shortest distance route, a route distance of each to-be-evaluated route may be evaluated using the shortest distance route. It is to be understood that a larger difference between distances of the to-be-evaluated route and the shortest distance route indicates that the to-be-evaluated route has a longer route distance and an evaluation result of the to-be-evaluated route is less satisfactory. When the target reference route is the shortest time route, a route travel time of each to-be-evaluated route may be evaluated using the shortest time route. It is to be understood that a larger difference between the route travel time of the to-be-evaluated route and the route travel time of the shortest time route indicates that the to-be-evaluated route needs to take a longer time and an evaluation result of the to-be-evaluated route is less satisfactory.

It is to be understood that since the target truth value data on user behaviors reflects the real behaviors of users between the first to-be-evaluated location and the second to-be-evaluated location, the target reference route determined according to the target truth value data on user behaviors has higher accuracy so that the accuracy of the route evaluation can be improved. Meanwhile, the target truth value data on user behaviors is automatically collected by the route planning client and the electronic device can acquire the target truth value data on user behaviors collected by the route planning client in real time so that a manual cost in a manual drive test method can be effectively saved and the target truth value data on user behaviors can be acquired with higher efficiency, thereby improving the efficiency of the route evaluation.

In the embodiment of the present disclosure, after the target truth value data on user behaviors between the first to-be-evaluated location and the second to-be-evaluated location and collected by the route planning client is acquired, the target reference route between the first to-be-evaluated location and the second to-be-evaluated location is determined according to the acquired target truth value data on user behaviors and then the to-be-evaluated route is evaluated according to the determined target reference route. Since the target truth value data on user behaviors is data on actual values objectively existing through measurement between the first to-be-evaluated location and the second to-be-evaluated location, the authenticity and effectiveness of the data can be ensured so that the accuracy and effectiveness of the target reference route can be ensured and the problems of a high labor cost, low efficiency, low accuracy and the like of the existing route evaluation method can be solved, thereby reducing the labor cost of the route evaluation and improving the accuracy and efficiency of the route evaluation.

In one example, FIG. 2 is a flowchart of a route evaluation method according to an embodiment of the present disclosure. This embodiment is optimized and improved based on the solution in the preceding embodiments and provides multiple implementations of the steps of acquiring target truth value data on user behaviors between a first to-be-evaluated location and a second to-be-evaluated location and collected by a route planning client and determining a target reference route.

As shown in FIG. 2, the route evaluation method includes steps described below.

In S210, truth value data on user behaviors which is uploaded by the route planning client in real time is acquired, and/or user feedback truth value data which is uploaded by an evaluation-assisting user through the route planning client is acquired.

The evaluation-assisting user may be a user providing data related to route evaluation. The user feedback truth value data may be truth value data uploaded by the evaluation-assisting user through the route planning client, such as a travel route, travel time and travel cost and other data between the first to-be-evaluated location and the second to-be-evaluated location and determined by the evaluation-assisting user according to actual travel experience. That is, the user feedback truth value data also belongs to the truth value data on user behaviors between the first to-be-evaluated location and the second to-be-evaluated location and is not data subjectively selected by the evaluation-assisting user.

In the embodiment of the present disclosure, the route planning client may acquire the truth value data on user behaviors in real time, for example, acquire the truth value data on user behaviors such as the movement trajectory, movement speed or movement time of a user according to navigation information of the user. Meanwhile, the route planning client may also receive the user feedback truth value data uploaded by the evaluation-assisting user. For example, after driving a vehicle along a route, the evaluation-assisting user uploads related data such as a travel trajectory, travel time, travel distance or travel cost recorded by the vehicle to the route planning client. Accordingly, after acquiring at least one of the truth value data on user behaviors and the user feedback truth value data, the route planning client may send the at least one of the truth value data on user behaviors and the user feedback truth value data to an electronic device.

In an embodiment of the present disclosure, before the target truth value data on user behaviors between the first to-be-evaluated location and the second to-be-evaluated location and collected by the route planning client is acquired, the method may further include screening the to-be-evaluated routes according to a route evaluation condition to obtain a target to-be-evaluated route.

The route evaluation condition may be a condition for determining the target to-be-evaluated route, and the target to-be-evaluated route may be a to-be-evaluated route that needs to be evaluated.

It is to be understood that in some route evaluation scenarios, part of the to-be-evaluated routes do not need to be evaluated in consideration of an effect of a distance between the first to-be-evaluated location and the second to-be-evaluated location or another geographical factor. Therefore, to reduce a calculation load of the electronic device, before the target truth value data on user behaviors between the first to-be-evaluated location and the second to-be-evaluated location and collected by the route planning client is acquired, the to-be-evaluated route may be screened so that the target to-be-evaluated route with an actual evaluation requirement is obtained.

In an embodiment of the present disclosure, the step of screening the to-be-evaluated route according to the route evaluation condition may include steps described below. At least one of a route distance threshold and an intermediate station number threshold included in the route evaluation condition is determined. In response to determining that a route distance between the first to-be-evaluated location and the second to-be-evaluated location is greater than or equal to the route distance threshold, the to-be-evaluated route is determined to be the target to-be-evaluated route. Additionally/alternatively, in response to determining that the number of stations between the first to-be-evaluated location and the second to-be-evaluated location is greater than or equal to the intermediate station number threshold, the to-be-evaluated route is determined to be the target to-be-evaluated route.

The route distance threshold may be a preset threshold for a route distance, such as 1 km or 2 km, and may be set according to evaluation requirements. The specific value of the route distance threshold is not limited in the embodiments of the present disclosure. The intermediate station number threshold may be a preset threshold for the number of stations between the first to-be-evaluated location and the second to-be-evaluated location, such as 1, 2, or 3, and may also be set according to the evaluation requirements. The specific value of the intermediate station number threshold is not limited in the embodiments of the present disclosure, either.

It is to be understood that when the distance between the first to-be-evaluated location and the second to-be-evaluated location is short enough, or when the number of intermediate stations (that is, stations other than the first to-be-evaluated location and the second to-be-evaluated location) between the first to-be-evaluated location and the second to-be-evaluated location is small enough for some public transport vehicles, there is generally one and only one route between the first to-be-evaluated location and the second to-be-evaluated location, where the route is not only the to-be-evaluated route between the two locations but also an optimal route between the two locations. Apparently, in the above case, the to-be-evaluated route between the first to-be-evaluated location and the second to-be-evaluated location does not need to be evaluated. In some cases, though there is only one to-be-evaluated route between the first to-be-evaluated location and the second to-be-evaluated location, the to-be-evaluated route might not be the optimal route between the first to-be-evaluated location and the second to-be-evaluated location and thus the to-be-evaluated route still needs to be evaluated.

In summary, to further improve the efficiency of route evaluation, when screening the to-be-evaluated route according to the route evaluation condition, the electronic device may determine at least one of the route distance threshold and the intermediate station number threshold included in the route evaluation condition and then screen the to-be-evaluated route according to the at least one of the route distance threshold and the intermediate station number threshold. In an embodiment, if it is determined that the route distance between the first to-be-evaluated location and the second to-be-evaluated location is greater than or equal to the route distance threshold and/or if it is determined that the number of stations between the first to-be-evaluated location and the second to-be-evaluated location is greater than or equal to the intermediate station number threshold, it indicates that the to-be-evaluated route between the first to-be-evaluated location and the second to-be-evaluated location has the evaluation requirement, for example, multiple to-be-evaluated routes exist or another feasible route still exists between the first to-be-evaluated location and the second to-be-evaluated location in the case where one to-be-evaluated route exists. In the case where it is determined that the to-be-evaluated route between the first to-be-evaluated location and the second to-be-evaluated location has the actual evaluation requirement, the to-be-evaluated route between the first to-be-evaluated location and the second to-be-evaluated location may be determined to be the target to-be-evaluated route, so as to evaluate the screened target to-be-evaluated route.

In S220, at least one of the truth value data on user behaviors and the user feedback truth value data is screened according to the first to-be-evaluated location and the second to-be-evaluated location so that the target truth value data on user behaviors is obtained.

Accordingly, after receiving at least one of the truth value data on user behaviors and the user feedback truth value data sent by the route planning client, the electronic device may screen the at least one of the truth value data on user behaviors and the user feedback truth value data according to information related to the first to-be-evaluated location and the second to-be-evaluated location so that the target truth value data on user behaviors is obtained.

Exemplarily, the electronic device may acquire geographical location data of the first to-be-evaluated location and geographical location data of the second to-be-evaluated location, and screen out user behavior data which ranges between the first to-be-evaluated location and the second to-be-evaluated location as the target truth value data on user behaviors according to the geographical location data. Further, after screening out the user behavior data which ranges between the first to-be-evaluated location and the second to-be-evaluated location, the electronic device may further screen the screened user behavior data according to the requirement of route evaluation, for example, screen the user behavior data corresponding to bus users as the target truth value data on user behaviors.

In the preceding solution, the target truth value data on user behaviors is screened out by using the truth value data uploaded by the route planning client in real time, which can ensure that the target truth value data on user behaviors is rich and detailed.

In an embodiment of the present disclosure, the to-be-evaluated route is a route planned for the public transport vehicle. The step in which the truth value data on user behaviors is screened according to the first to-be-evaluated location and the second to-be-evaluated location may include: determining to-be-evaluated truth value data on user behaviors between the first to-be-evaluated location and the second to-be-evaluated location according to the truth value data on user behaviors; and in response to determining that the to-be-evaluated truth value data on user behaviors includes truth value data on group user behaviors, using the truth value data on group user behaviors as the target truth value data on user behaviors.

The route planned for the public transport vehicle is a planned route of the public transport vehicle, such as a route planned for a bus, a route planned for a subway or a route comprehensively planned for multiple different public transport vehicles. The to-be-evaluated truth value data on user behaviors may be the user behavior data which ranges between the first to-be-evaluated location and the second to-be-evaluated location. The truth value data on group user behaviors may be truth value data on user behaviors of group users with the same user behaviors. Exemplarily, the truth value data on group user behaviors may be the synchronous movement trajectory, positioning, movement speed, pause time and the like of more than a certain number of group users. The number of users included in the group users may be set according to an actual requirement, such as 5 or 10. The number of users included in the group users is not limited in the embodiment of the present disclosure.

In an embodiment, the electronic device may screen the truth value data on user behaviors in consideration of requirements of different route evaluation scenarios. In an embodiment, the electronic device may screen out the to-be-evaluated truth value data on user behaviors between the first to-be-evaluated location and the second to-be-evaluated location according to the truth value data on user behaviors, for example, acquire the geographical location data of the first to-be-evaluated location and the geographical location data of the second to-be-evaluated location and screen out the to-be-evaluated truth value data on user behaviors which ranges between the first to-be-evaluated location and the second to-be-evaluated location according to the geographical location data. Further, the electronic device may determine whether the screened to-be-evaluated truth value data on user behaviors include the truth value data on group user behaviors. If it is determined that the to-be-evaluated truth value data on user behaviors includes the truth value data on group user behaviors, the truth value data on group user behaviors may be screened out and used as the target truth value data on user behaviors.

It is to be understood that the group user behaviors reflect the synchronous real behaviors of the group users. Therefore, the preceding scheme in which the truth value data on group user behaviors is used as the target truth value data on user behaviors is applicable to the scenario where planned routes are evaluated which correspond to the public transport vehicle such as the bus, the subway or a light rail that can carry a large number of users. In this scenario, the first to-be-evaluated location and the second to-be-evaluated location may be two stations at which the public transport vehicle stops. Accordingly, the truth value data on group user behaviors is subjected to a data analysis so that the target reference route between the first to-be-evaluated location and the second to-be-evaluated location is obtained and the to-be-evaluated planned routes of the public transport vehicle between the first to-be-evaluated location and the second to-be-evaluated location can be evaluated through the target reference route, which is convenient for a public transport company to adjust route operation planning according to an evaluation result of the to-be-evaluated route to improve the operation benefits of the company and the riding experience of users.

In an embodiment of the present disclosure, the step of determining that the to-be-evaluated truth value data on user behaviors includes the truth value data on group user behaviors may include: acquiring a user movement time, a user movement route and a user pause location included in the to-be-evaluated truth value data on user behaviors; determining target to-be-evaluated truth value data on user behaviors where the user movement route matches a planned travel route and the user pause location matches a planned parking location within the same user movement time; counting the number of pieces of target truth value data according to the target to-be-evaluated truth value data on user behaviors; and in response to determining that the number of pieces of target truth value data is greater than or equal to a preset user number threshold, determining the target to-be-evaluated truth value data on user behaviors with the number of pieces of target truth value data to be the truth value data on group user behaviors.

The user movement time may be a time for which each user moves between the first to-be-evaluated location and the second to-be-evaluated location, the user movement route may be a route along which each user moves between the first to-be-evaluated location and the second to-be-evaluated location, and the user pause location may be a location at which each user pauses between the first to-be-evaluated location and the second to-be-evaluated location. It is to be understood that the number of the user pause location may be one or more or may be zero. When the number of the user pause location is zero, it indicates that the user travels directly from the first to-be-evaluated location to the second to-be-evaluated location without a pause. The planned travel route may be one of the at least one to-be-evaluated route. The planned parking location may be a pre-planned parking location in the planned travel route, such as a bus station or a subway station. The target to-be-evaluated truth value data on user behaviors may be truth value data on user behaviors corresponding to a certain number of users and determined according to the user movement time, the user movement route, and the user pause location. The number of pieces of target truth value data may be a total number of users having the target to-be-evaluated truth value data on user behaviors. The preset user number threshold may be set according to the actual requirement, such as 5, 10, 15 or 20. The specific value of the preset user number threshold is not limited in the embodiments of the present disclosure.

In an embodiment, when it is determined whether the to-be-evaluated truth value data on user behaviors includes the truth value data on group user behaviors, relevant information such as the user movement time, the user movement route and the user pause location included in the to-be-evaluated truth value data on user behaviors may be acquired and it is further determined whether the to-be-evaluated truth value data on user behaviors where the user movement route matches the planned travel route and the user pause location matches the planned parking location within the same user movement time exists. If it is determined that the to-be-evaluated truth value data on user behaviors where the user movement route matches the planned travel route and the user pause location matches the planned parking location within the same user movement time exists, this to-be-evaluated truth value data on user behaviors is determined to be the target to-be-evaluated truth value data on user behaviors. For example, the to-be-evaluated truth value data on user behaviors where synchronous movement and pauses exist, pause locations are all near the bus station, and the movement trajectory matches data on an existing bus route within the same time is determined to be the target to-be-evaluated truth value data on user behaviors. Since each piece of the target to-be-evaluated truth value data on user behaviors may correspond to one user identifier, the number of target to-be-evaluated users may be determined to be the number of pieces of target truth value data according to the target to-be-evaluated truth value data on user behaviors, where the target to-be-evaluated user is a user corresponding to each piece of target to-be-evaluated truth value data on user behaviors. Accordingly, if it is determined that the counted number of pieces of the target truth value data is greater than or equal to the preset user number threshold, it indicates that the group user behaviors exist and the target to-be-evaluated truth value data on user behaviors with the number of pieces of target truth value data may be determined to be the truth value data on group user behaviors.

In the preceding solution, whether the to-be-evaluated truth value data on user behaviors includes the truth value data on group user behaviors can be quickly and effectively determined by using the to-be-evaluated truth value data on user behaviors such as the user movement time, the user movement route and the user pause location.

In an embodiment of the present disclosure, the step of using the truth value data on group user behaviors as the target truth value data on user behaviors may include: acquiring user forward behavior data included in the truth value data on group user behaviors; screening the truth value data on group user behaviors according to the user forward behavior data to obtain target truth value data on group user behaviors; and using the target truth value data on group user behaviors as the target truth value data on user behaviors.

The user forward behavior data may be behavior data of the user before the first to-be-evaluated location or the second to-be-evaluated location. In an embodiment, when the first to-be-evaluated location is a start point, the user forward behavior data may be the behavior data of the user before the first to-be-evaluated location; and when the second to-be-evaluated location is the start point, the user forward behavior data may be the behavior data of the user before the second to-be-evaluated location. The target truth value data on group user behaviors may be truth value data on group user behaviors obtained after the truth value data on group user behaviors is screened using the user forward behavior data.

To further ensure the effectiveness and accuracy of the truth value data on group user behaviors and prevent the truth value data on group user behaviors from being doped with the truth value data on non-group user behaviors. In an embodiment, after the truth value data on group user behaviors is initially acquired, the electronic device may further acquire the user forward behavior data included in the truth value data on group user behaviors. The user forward behavior data reflects a behavior pattern of the user before the user arrives at the first to-be-evaluated location or the second to-be-evaluated location, for example, the user typically arrives at the first to-be-evaluated location or the second to-be-evaluated location on foot. Therefore, the acquired user forward behavior data may be further analyzed and screened so that the target truth value data on group user behaviors is obtained, which is real and effective.

Exemplarily, assuming that the route planned for the bus needs to be evaluated, the first to-be-evaluated location and the second to-be-evaluated location are two bus stations. After the truth value data on group user behaviors between the first to-be-evaluated location and the second to-be-evaluated location is acquired, the user forward behavior data of each of the group users may be acquired according to user identifiers in the truth value data on group user behaviors and analyzed one by one. Assuming that the first to-be-evaluated location is the start point of the to-be-evaluated route, if travel trajectories in the user forward behavior data of part of users are walking trajectories and end points of the travel trajectories are the first to-be-evaluated location, it may be determined that truth value data on behaviors of these users is the target truth value data on group user behaviors. This manner for screening out the target truth value data on group user behaviors can effectively prevent truth value data on user behaviors of an individual vehicle from being mistaken as the truth value data on group user behaviors when the individual vehicle synchronous travels with the bus, thereby improving the effectiveness and accuracy of the target truth value data on group user behaviors.

In an embodiment of the present disclosure, the step in which the truth value data on user behaviors is screened according to the first to-be-evaluated location and the second to-be-evaluated location may include: determining the to-be-evaluated truth value data on user behaviors between the first to-be-evaluated location and the second to-be-evaluated location according to the truth value data on user behaviors; determining a trajectory type identifier included in the to-be-evaluated truth value data on user behaviors; and in response to determining that the trajectory type identifier is a target trajectory type identifier, determining to-be-evaluated truth value data on user behaviors including the target trajectory type identifier to be the target truth value data on user behaviors.

The trajectory type identifier may be used for identifying a trajectory type of a corresponding user in the to-be-evaluated truth value data on user behaviors. The target trajectory type identifier may be a trajectory type identifier matching the type of the to-be-evaluated route.

In an embodiment, the target truth value data on user behaviors may also be determined by the trajectory type identifier. Accordingly, the electronic device may extract the trajectory type identifier included in the to-be-evaluated truth value data on user behaviors and analyze the extracted trajectory type identifier. If it is determined that the trajectory type identifier is the target trajectory type identifier, the to-be-evaluated truth value data on user behaviors including the target trajectory type identifier is determined to be the target truth value data on user behaviors. This manner for determining the target truth value data on user behaviors is quick and effective. The target truth value data on user behaviors can be quickly determined as long as the target trajectory type identifier is identified, without analyzing the user movement route, the user movement time, the user pause location, the user forward behavior data and the like included in the to-be-evaluated truth value data on user behaviors.

Exemplarily, a trajectory type identifier A is used for identifying the route planned for the bus, a trajectory type identifier B is used for identifying a route planned for a private car, a trajectory type identifier C is used for identifying a walking route, and a trajectory type identifier D is used for identifying a planned route of a mixed type. The planned route of the mixed type includes two or more types of planned routes. Exemplarily, the trajectory type identifier D may be further identified as a trajectory type identifier D-A when the planned route of the mixed type is identified to include the route planned for the bus. Assuming that the type of the to-be-evaluated route is the route planned for the bus, the electronic device may extract the trajectory type identifier included in the to-be-evaluated truth value data on user behaviors and directly determine to-be-evaluated truth value data on user behaviors including the trajectory type identifier A to be the target truth value data on user behaviors. It is to be noted that the trajectory type identifier included in the target truth value data on user behaviors may be the trajectory type identifier A or the trajectory type identifier D-A as long as the trajectory type identifier A is included, which is not limited in the embodiment of the present disclosure.

In an embodiment of the present disclosure, the step in which the user feedback truth value data is screened according to the first to-be-evaluated location and the second to-be-evaluated location may include: in response to determining that the user feedback truth value data includes the first to-be-evaluated location and the second to-be-evaluated location, taking target user feedback truth value data from the user feedback truth value data, where route cutoff points in the target user feedback truth value data are the first to-be-evaluated location and the second to-be-evaluated location; and using the target user feedback truth value data as the target truth value data on user behaviors.

The target user feedback truth value data may be part of the user feedback truth value data. The route cutoff points are the start point and the end point of the route.

It is to be understood that relevant route data included in the user feedback truth value data might not exactly match the to-be-evaluated route. For example, route cutoff points in the user feedback truth value data are different from the first to-be-evaluated location and the second to-be-evaluated location. Therefore, the user feedback truth value data needs to be screened so that the target truth value data on user behaviors, which is real and effective, is obtained according to a screening result. In an embodiment, the electronic device may analyze whether the user feedback truth value data includes the first to-be-evaluated location and the second to-be-evaluated location, take the target user feedback truth value data with the first to-be-evaluated location and the second to-be-evaluated location as the route cutoff points from the user feedback truth value data if determining that the user feedback truth value data includes the first to-be-evaluated location and the second to-be-evaluated location, and use the target user feedback truth value data as the target truth value data on user behaviors.

Exemplarily, it is assumed that the user feedback truth value data is data related to a route a-b-c-d-e, where a, b, c, d and e denote locations with actual geographical locations, such as bus stations. If the first to-be-evaluated location is a location b and the second to-be-evaluated location is a location d, the target user feedback truth value data may be user feedback truth value data corresponding to a route b-c-d.

In the preceding solution, the target user feedback truth value data is taken from the user feedback truth value data, which can ensure that the route corresponding to the target user feedback truth value data matches the first to-be-evaluated location and the second to-be-evaluated location and can truly satisfy the evaluation requirement of the to-be-evaluated route.

In S230, user travel-associated data included in the target truth value data on user behaviors is extracted, where the user travel-associated data includes at least one of a user travel trajectory, a user travel time or a user travel cost.

The user travel-associated data may be related data embodying user travel characteristics. The user travel trajectory is information about the user travel trajectory such as a type or a length. The user travel time may be a time for which the user travels between the first to-be-evaluated location and the second to-be-evaluated location. The user travel cost may be a cost required by the user to travel between the first to-be-evaluated location and the second to-be-evaluated location and may include, but is not limited to, a riding cost, a fuel charge, a highway charge or the like, which is not limited in the embodiment of the present disclosure.

In S240, the target reference route is calculated according to the user travel-associated data.

In the embodiment of the present disclosure, after acquiring the target truth value data on user behaviors, the electronic device may extract the user travel-associated data such as the user travel trajectory, the user travel time and the user travel cost included in the target truth value data on user behaviors to calculate the target reference route according to the extracted user travel-associated data. For example, the electronic device orders travel routes included in the target truth value data on user behaviors according to evaluation factors such as the length of the user travel trajectory, the length of the user travel time and the amount of the user travel cost; and comprehensively calculates sorting results to obtain an optimal route such as a shortest distance route, a shortest time route, a lowest cost route or a comprehensive optimal route.

In the preceding solution, since the target truth value data on user behaviors can ensure data authenticity, the target reference route calculated according to the user travel-associated data included in the target truth value data on user behaviors is the actual optimal route with, for example, a shortest distance, a shortest time or a lowest cost.

In S250, the target to-be-evaluated route is evaluated according to the target reference route.

Accordingly, after screening the to-be-evaluated route according to the route evaluation condition to obtain the target to-be-evaluated route, the electronic device may acquire only target truth value data on user behaviors between the first to-be-evaluated location and the second to-be-evaluated location and including the target to-be-evaluated route, determine the target reference route according to the acquired target truth value data on user behaviors, and evaluate the target to-be-evaluated route according to the determined target reference route to avoid evaluating a route that does not need to be evaluated, thereby further improving the efficiency of route evaluation.

In the preceding solution, the target to-be-evaluated route with the evaluation requirement is screened out, the target truth value data on user behaviors between the first to-be-evaluated location and the second to-be-evaluated location and collected by the route planning client is acquired in multiple manners, and the target reference route between the first to-be-evaluated location and the second to-be-evaluated location is determined according to the acquired target truth value data on user behaviors so that the target to-be-evaluated route obtained through the screening is evaluated according to the target reference route, which can effectively reduce a labor cost due to drive tests, acquire real data from a large number of users, and thus obtain a route evaluation result which is more efficient, more objective and more accurate.

It is to be noted that the acquisition, storage and application of user personal information and related data such as the target truth value data on user behaviors, the truth value data on user behaviors and the user feedback truth value data involved in the solutions of the present disclosure all comply with relevant laws and regulations and do not violate the good order and custom.

It is to be noted that any arrangement and combination of various technical features in the preceding embodiments are also within the scope of the present disclosure.

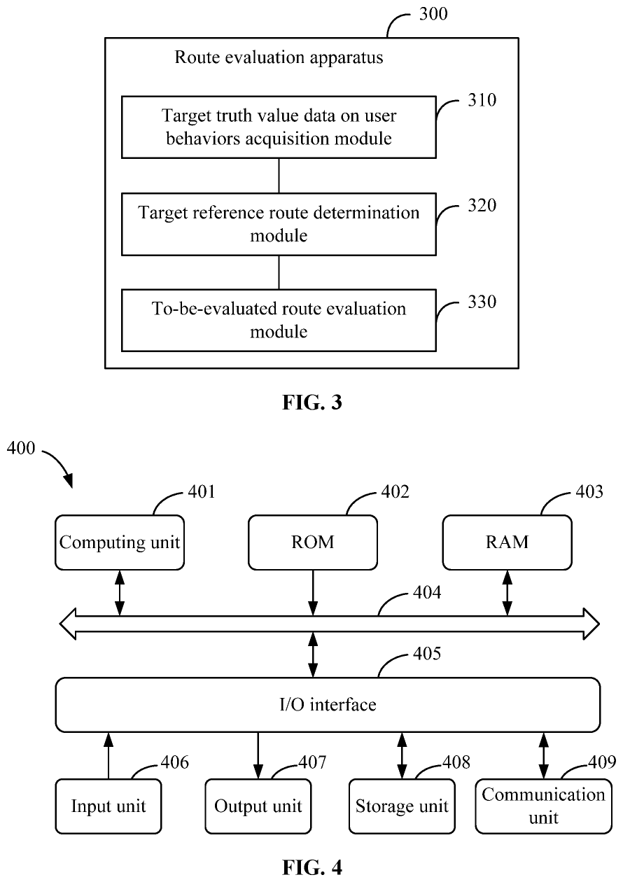

In one example, FIG. 3 is a structure diagram of a route evaluation apparatus according to an embodiment of the present disclosure. This embodiment is applicable to the case where route evaluation is performed according to target truth value data on user behaviors between two locations and collected by a route planning client. The apparatus is implemented by software and/or hardware and configured in an electronic device. The electronic device may exchange data with the route planning client and may be a terminal device, a server device or the like.

As shown in FIG. 3, the route evaluation apparatus 300 includes a target truth value data on user behaviors acquisition module 310, a target reference route determination module 320 and a to-be-evaluated route evaluation module 330.

The target truth value data on user behaviors acquisition module 310 is configured to acquire the target truth value data on user behaviors between a first to-be-evaluated location and a second to-be-evaluated location and collected by the route planning client, where to-be-evaluated route is included between the first to-be-evaluated location and the second to-be-evaluated location.

The target reference route determination module 320 is configured to determine a target reference route between the first to-be-evaluated location and the second to-be-evaluated location according to the target truth value data on user behaviors.

The to-be-evaluated route evaluation module 330 is configured to evaluate the to-be-evaluated route according to the target reference route.

In the embodiment of the present disclosure, after the target truth value data on user behaviors between the first to-be-evaluated location and the second to-be-evaluated location and collected by the route planning client is acquired, the target reference route between the first to-be-evaluated location and the second to-be-evaluated location is determined according to the acquired target truth value data on user behaviors and then the to-be-evaluated route is evaluated according to the determined target reference route. Since the target truth value data on user behaviors is data on actual values objectively existing through measurement between the first to-be-evaluated location and the second to-be-evaluated location, the authenticity and effectiveness of the data can be ensured so that the accuracy and effectiveness of the target reference route can be ensured and the problems of a high labor cost, low efficiency, low accuracy and the like of the existing route evaluation method can be solved, thereby reducing the labor cost of the route evaluation and improving the accuracy and efficiency of the route evaluation.

In an embodiment, the target truth value data on user behaviors acquisition module 310 is configured to: acquire truth value data on user behaviors uploaded by the route planning client in real time and/or acquire user feedback truth value data uploaded by an evaluation-assisting user through the route planning client; and screen at least one of the truth value data on user behaviors and the user feedback truth value data according to the first to-be-evaluated location and the second to-be-evaluated location to obtain the target truth value data on user behaviors.

In an embodiment, the to-be-evaluated route is a route planned for a public transport vehicle. The target truth value data on user behaviors acquisition module 310 is configured to: determine to-be-evaluated truth value data on user behaviors between the first to-be-evaluated location and the second to-be-evaluated location according to the truth value data on user behaviors; and in response to determining that the to-be-evaluated truth value data on user behaviors includes truth value data on group user behaviors, use the truth value data on group user behaviors as the target truth value data on user behaviors.

In an embodiment, the target truth value data on user behaviors acquisition module 310 is configured to: acquire a user movement time, a user movement route and a user pause location included in the to-be-evaluated truth value data on user behaviors; determine target to-be-evaluated truth value data on user behaviors where the user movement route matches a planned travel route and the user pause location matches a planned parking location within the same user movement time; count the number of pieces of target truth value data according to the target to-be-evaluated truth value data on user behaviors; and in response to determining that the number of pieces of target truth value data is greater than or equal to a preset user number threshold, determine the target to-be-evaluated truth value data on user behaviors with the number of pieces of target truth value data to be the truth value data on group user behaviors.

In an embodiment, the target truth value data on user behaviors acquisition module 310 is configured to: acquire user forward behavior data included in the truth value data on group user behaviors; screen the truth value data on group user behaviors according to the user forward behavior data to obtain target truth value data on group user behaviors; and use the target truth value data on group user behaviors as the target truth value data on user behaviors.

In an embodiment, the target truth value data on user behaviors acquisition module 310 is configured to: determine the to-be-evaluated truth value data on user behaviors between the first to-be-evaluated location and the second to-be-evaluated location according to the truth value data on user behaviors; determine a trajectory type identifier included in the to-be-evaluated truth value data on user behaviors; and in response to determining that the trajectory type identifier is a target trajectory type identifier, determine to-be-evaluated truth value data on user behaviors including the target trajectory type identifier to be the target truth value data on user behaviors.

In an embodiment, the target truth value data on user behaviors acquisition module 310 is configured to: in response to determining that the user feedback truth value data includes the first to-be-evaluated location and the second to-be-evaluated location, take target user feedback truth value data from the user feedback truth value data, where route cutoff points in the target user feedback truth value data are the first to-be-evaluated location and the second to-be-evaluated location; and use the target user feedback truth value data as the target truth value data on user behaviors.

In an embodiment, the target reference route determination module 320 is configured to: extract user travel-associated data included in the target truth value data on user behaviors, where the user travel-associated data includes at least one of a user travel trajectory, a user travel time and a user travel cost; and calculate the target reference route according to the user travel-associated data. The target reference route includes at least one of a shortest distance route, a shortest time route, a lowest cost route and a comprehensive optimal route.

In an embodiment, the route evaluation apparatus further includes a to-be-evaluated route screening module configured to screen the to-be-evaluated route according to a route evaluation condition to obtain a target to-be-evaluated route. The to-be-evaluated route evaluation module 330 is configured to evaluate the target to-be-evaluated route according to the target reference route.

In an embodiment, the to-be-evaluated route screening module is configured to: determine at least one of a route distance threshold and an intermediate station number threshold included in the route evaluation condition; and in response to determining that a route distance between the first to-be-evaluated location and the second to-be-evaluated location is greater than or equal to the route distance threshold, determine the to-be-evaluated route to be the target to-be-evaluated route; and/or in response to determining that the number of stations between the first to-be-evaluated location and the second to-be-evaluated location is greater than or equal to the intermediate station number threshold, determine the to-be-evaluated route to be the target to-be-evaluated route.

The preceding route evaluation apparatus may perform the route evaluation method provided by any embodiment of the present disclosure and has function modules and beneficial effects corresponding to the performed method. For technical details not described in detail in this embodiment, reference may be made to the route evaluation method provided by any embodiment of the present disclosure.

The preceding route evaluation apparatus is an apparatus that can execute the route evaluation method in the embodiments of the present disclosure. Therefore, based on the route evaluation method described in the embodiments of the present disclosure, those skilled in the art can understand embodiments of the route evaluation apparatus in this embodiment and various variations thereof. Thus, how the route evaluation apparatus implements the route evaluation method in the embodiments of the present disclosure is not described in detail here. Any apparatus used by those skilled in the art to implement the route evaluation method in the embodiments of the present disclosure falls within the scope of the present disclosure.

In one example, the present disclosure further provides an electronic device, a readable storage medium and a computer program product.

FIG. 4 is a block diagram of an example electronic device 400 for implementing an embodiment of the present disclosure. Electronic devices are intended to represent various forms of digital computers, for example, laptop computers, desktop computers, worktables, personal digital assistants, servers, blade servers, mainframe computers and other applicable computers. Electronic devices may also represent various forms of mobile devices, for example, personal digital assistants, cellphones, smartphones, wearable devices and other similar computing devices. Herein the shown components, the connections and relationships between these components, and the functions of these components are illustrative only and are not intended to limit the implementation of the present disclosure as described and/or claimed herein.

As shown in FIG. 4, the device 400 includes a computing unit 401. The computing unit 401 may perform various appropriate actions and processing according to a computer program stored in a read-only memory (ROM) 402 or a computer program loaded into a random-access memory (RAM) 403 from a storage unit 408. The RAM 403 may also store various programs and data required for operations of the device 400. The computing unit 401, the ROM 402 and the RAM 403 are connected to each other by a bus 404. An input/output (I/O) interface 405 is also connected to the bus 404.

Multiple components in the device 400 are connected to the I/O interface 405. The multiple components include an input unit 406 such as a keyboard or a mouse, an output unit 407 such as various types of displays or speakers, the storage unit 408 such as a magnetic disk or an optical disk, and a communication unit 409 such as a network card, a modem or a wireless communication transceiver. The communication unit 409 allows the device 400 to exchange information/data with other devices over a computer network such as the Internet and/or over various telecommunication networks.

The computing unit 401 may be a general-purpose and/or special-purpose processing component having processing and computing capabilities. Examples of the computing unit 401 include, but are not limited to, a central processing unit (CPU), a graphics processing unit (GPU), a special-purpose artificial intelligence (AI) computing chip, a computing unit executing machine learning model algorithms, a digital signal processor (DSP), and any appropriate processor, controller and microcontroller. The computing unit 401 performs various methods and processing described above, such as the route evaluation method. For example, in some embodiments, the route evaluation method may be implemented as a computer software program tangibly contained in a machine-readable medium such as the storage unit 408. In some embodiments, part or all of computer programs may be loaded and/or installed on the device 400 via the ROM 402 and/or the communication unit 409. When the computer programs are loaded to the RAM 403 and executed by the computing unit 401, one or more steps of the preceding route evaluation method may be performed. Alternatively, in other embodiments, the computing unit 401 may be configured, in any other suitable manner (for example, by means of firmware), to perform the route evaluation method.

Herein various embodiments of the systems and techniques described above may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), and computer hardware, firmware, software and/or combinations thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input device and at least one output device and transmitting data and instructions to the memory system, the at least one input device and the at least one output device.

Program codes for implementation of the method of the present disclosure may be written in any combination of one or more programming languages. These program codes may be provided for the processor or controller of a general-purpose computer, a special-purpose computer or another programmable data processing device to enable functions/operations specified in a flowchart and/or a block diagram to be implemented when the program codes are executed by the processor or controller. The program codes may all be executed on a machine; may be partially executed on a machine; may serve as a separate software package that is partially executed on a machine and partially executed on a remote machine; or may all be executed on a remote machine or a server.

In the context of the present disclosure, the machine-readable medium may be a tangible medium that contains or stores a program available for an instruction execution system, apparatus or device or a program used in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any appropriate combination thereof. Concrete examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device, or any appropriate combination thereof

In order that interaction with a user is provided, the systems and techniques described herein may be implemented on a computer. The computer has a display device (for example, a cathode-ray tube (CRT) or liquid-crystal display (LCD) monitor) for displaying information to the user; and a keyboard and a pointing device (for example, a mouse or a trackball) through which the user can provide input to the computer. Other types of devices may also be used for providing interaction with a user. For example, feedback provided for the user may be sensory feedback in any form (for example, visual feedback, auditory feedback or haptic feedback). Moreover, input from the user may be received in any form (including acoustic input, voice input or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein) or a computing system including any combination of such back-end, middleware or front-end components. The components of the system may be interconnected by any form or medium of digital data communication (for example, a communication network). Examples of the communication network include a local area network (LAN), a wide area network (WAN), a blockchain network and the Internet.

The computing system may include clients and servers. A client and a server are generally remote from each other and typically interact through a communication network. The relationship between the client and the server arises by virtue of computer programs running on the respective computers and having a client-server relationship to each other. The server may be a cloud server, also referred to as a cloud computing server or a cloud host. As a host product in a cloud computing service system, the server solves the defects of difficult management and weak service scalability in a related physical host and a related virtual private server (VPS).

In the embodiment of the present disclosure, after target truth value data on user behaviors between a first to-be-evaluated location and a second to-be-evaluated location and collected by a route planning client is acquired, a target reference route between the first to-be-evaluated location and the second to-be-evaluated location is determined according to the acquired target truth value data on user behaviors and then a to-be-evaluated route is evaluated according to the determined target reference route. Since the target truth value data on user behaviors is data on actual values objectively existing through measurement between the first to-be-evaluated location and the second to-be-evaluated location, the authenticity and effectiveness of the data can be ensured so that the accuracy and effectiveness of the target reference route can be ensured and the problems of a high labor cost, low efficiency, low accuracy and the like of the existing route evaluation method can be solved, thereby reducing the labor cost of route evaluation and improving the accuracy and efficiency of the route evaluation.

It is to be understood that various forms of the preceding flows may be used, with steps reordered, added or removed. For example, the steps described in the present disclosure may be executed in parallel, in sequence or in a different order as long as the desired result of the technical solution disclosed in the present disclosure is achieved. The execution sequence of these steps is not limited herein.

The scope of the present disclosure is not limited to the preceding embodiments. It is to be understood by those skilled in the art that various modifications, combinations, sub-combinations and substitutions may be made depending on design requirements and other factors. Any modifications, equivalent substitutions, improvements and the like made within the spirit and principle of the present disclosure are within the scope of the present disclosure.

What is claimed is:

1. A route evaluation method, comprising:
acquiring target truth value data on user behaviors between a first to-be-evaluated location and a second to-be-evaluated location and collected by a route planning client, wherein at least one to-be-evaluated route is comprised between the first to-be-evaluated location and the second to-be-evaluated location;
determining a target reference route between the first to-be-evaluated location and the second to-be-evaluated location according to the target truth value data on user behaviors; and
evaluating the at least one to-be-evaluated route according to the target reference route.

2. The method of claim 1, wherein acquiring the target truth value data on user behaviors between the first to-be-evaluated location and the second to-be-evaluated location and collected by the route planning client comprises:
at least one of: acquiring truth value data on user behaviors uploaded by the route planning client in real time, or acquiring user feedback truth value data uploaded by an evaluation-assisting user-side through the route planning client; and
screening at least one of the truth value data on user behaviors or the user feedback truth value data according to the first to-be-evaluated location and the second to-be-evaluated location to obtain the target truth value data on user behaviors.

3. The method of claim 2, wherein the at least one to-be-evaluated route is a route planned for a public transport vehicle;
wherein screening the truth value data on user behaviors according to the first to-be-evaluated location and the second to-be-evaluated location comprises:
determining to-be-evaluated truth value data on user behaviors between the first to-be-evaluated location and the second to-be-evaluated location according to the truth value data on user behaviors; and
in response to determining that the to-be-evaluated truth value data on user behaviors comprises truth value data on group user behaviors, using the truth value data on group user behaviors as the target truth value data on user behaviors.

4. The method of claim 3, wherein determining that the to-be-evaluated truth value data on user behaviors comprises the truth value data on group user behaviors comprises:
acquiring a user movement time, a user movement route and a user pause location comprised in the to-be-evaluated truth value data on user behaviors;
determining target to-be-evaluated truth value data on user behaviors where the user movement route matches a planned travel route and the user pause location matches a planned parking location within a same user movement time;
counting a number of pieces of target truth value data according to the target to-be-evaluated truth value data on user behaviors; and
in response to determining that the number of pieces of target truth value data is greater than or equal to a preset user number threshold, determining the target to-be-evaluated truth value data on user behaviors with the number of pieces of target truth value data to be the truth value data on group user behaviors.

5. The method of claim 3, wherein using the truth value data on group user behaviors as the target truth value data on user behaviors comprises:
acquiring user forward behavior data comprised in the truth value data on group user behaviors;
screening the truth value data on group user behaviors according to the user forward behavior data to obtain target truth value data on group user behaviors; and
using the target truth value data on group user behaviors as the target truth value data on user behaviors.

6. The method of claim 4, wherein using the truth value data on group user behaviors as the target truth value data on user behaviors comprises:
acquiring user forward behavior data comprised in the truth value data on group user behaviors;
screening the truth value data on group user behaviors according to the user forward behavior data to obtain target truth value data on group user behaviors; and
using the target truth value data on group user behaviors as the target truth value data on user behaviors.

7. The method of claim 2, wherein screening the truth value data on user behaviors according to the first to-be-evaluated location and the second to-be-evaluated location comprises:
determining to-be-evaluated truth value data on user behaviors between the first to-be-evaluated location and the second to-be-evaluated location according to the truth value data on user behaviors;
determining a trajectory type identifier comprised in the to-be-evaluated truth value data on user behaviors; and
in response to determining that the trajectory type identifier is a target trajectory type identifier, determining to-be-evaluated truth value data on user behaviors comprising the target trajectory type identifier to be the target truth value data on user behaviors.

8. The method of claim 2, wherein screening the user feedback truth value data according to the first to-be-evaluated location and the second to-be-evaluated location comprises:
in response to determining that the user feedback truth value data comprises the first to-be-evaluated location and the second to-be-evaluated location, taking target user feedback truth value data from the user feedback truth value data, wherein route cutoff points in the target user feedback truth value data are the first to-be-evaluated location and the second to-be-evaluated location; and
using the target user feedback truth value data as the target truth value data on user behaviors.

9. The method of claim 1, wherein determining the target reference route between the first to-be-evaluated location and the second to-be-evaluated location according to the target truth value data on user behaviors comprises:
extracting user travel-associated data comprised in the target truth value data on user behaviors, wherein the user travel-associated data comprises at least one of a user travel trajectory, a user travel time or a user travel cost; and
calculating the target reference route according to the user travel-associated data;
wherein the target reference route comprises at least one of a shortest distance route, a shortest time route, a lowest cost route or a comprehensive optimal route.

10. The method of claim 1, further comprising:
screening the at least one to-be-evaluated route according to a route evaluation condition to obtain a target to-be-evaluated route;
wherein evaluating the at least one to-be-evaluated route according to the target reference route comprises:
evaluating the target to-be-evaluated route according to the target reference route.

11. The method of claim 9, wherein screening the at least one to-be-evaluated route according to the route evaluation condition comprises:
determining at least one of a route distance threshold or an intermediate station number threshold comprised in the route evaluation condition; and
at least one of: in response to determining that a route distance between the first to-be-evaluated location and the second to-be-evaluated location is greater than or equal to the route distance threshold, determining the at least one to-be-evaluated route to be the target to-be-evaluated route; or in response to determining that a number of stations between the first to-be-evaluated location and the second to-be-evaluated location is greater than or equal to the intermediate station number threshold, determining the at least one to-be-evaluated route to be the target to-be-evaluated route.

12. An electronic device, comprising:
at least one processor; and
a memory communicatively connected to the at least one processor;
wherein the memory stores instructions executable by the at least one processor, and the processor is configured to:
acquire target truth value data on user behaviors between a first to-be-evaluated location and a second to-be-evaluated location and collected by a route planning client, wherein at least one to-be-evaluated route is comprised between the first to-be-evaluated location and the second to-be-evaluated location;
determine a target reference route between the first to-be-evaluated location and the second to-be-evaluated location according to the target truth value data on user behaviors; and
evaluate the at least one to-be-evaluated route according to the target reference route.

13. The electronic device of claim 12, wherein the processor is configured to acquire the target truth value data on user behaviors between the first to-be-evaluated location and the second to-be-evaluated location and collected by the route planning client in the following manners:
at least one of: acquiring truth value data on user behaviors uploaded by the route planning client in real time, or acquiring user feedback truth value data uploaded by an evaluation-assisting user-side through the route planning client; and
screening at least one of the truth value data on user behaviors or the user feedback truth value data according to the first to-be-evaluated location and the second to-be-evaluated location to obtain the target truth value data on user behaviors.

14. The electronic device of claim 13, wherein the at least one to-be-evaluated route is a route planned for a public transport vehicle;
wherein the processor is configured to screen the truth value data on user behaviors according to the first to-be-evaluated location and the second to-be-evaluated location in the following manners:
determining to-be-evaluated truth value data on user behaviors between the first to-be-evaluated location and the second to-be-evaluated location according to the truth value data on user behaviors; and
in response to determining that the to-be-evaluated truth value data on user behaviors comprises truth value data on group user behaviors, using the truth value data on group user behaviors as the target truth value data on user behaviors.

15. The electronic device of claim 14, wherein the processor is configured to determine that the to-be-evaluated truth value data on user behaviors comprises the truth value data on group user behaviors in the following manners:
acquiring a user movement time, a user movement route and a user pause location comprised in the to-be-evaluated truth value data on user behaviors;
determining target to-be-evaluated truth value data on user behaviors where the user movement route matches a planned travel route and the user pause location matches a planned parking location within a same user movement time;
counting a number of pieces of target truth value data according to the target to-be-evaluated truth value data on user behaviors; and
in response to determining that the number of pieces of target truth value data is greater than or equal to a preset user number threshold, determining the target to-be-evaluated truth value data on user behaviors with the number of pieces of target truth value data to be the truth value data on group user behaviors.

16. The electronic device of claim 14, wherein the processor is configured to use the truth value data on group user behaviors as the target truth value data on user behaviors in the following manners:
acquiring user forward behavior data comprised in the truth value data on group user behaviors;
screening the truth value data on group user behaviors according to the user forward behavior data to obtain target truth value data on group user behaviors; and
using the target truth value data on group user behaviors as the target truth value data on user behaviors.

17. A non-transitory computer-readable storage medium storing computer instructions for causing a computer to perform:
acquiring target truth value data on user behaviors between a first to-be-evaluated location and a second to-be-evaluated location and collected by a route planning client, wherein at least one to-be-evaluated route is comprised between the first to-be-evaluated location and the second to-be-evaluated location;
determining a target reference route between the first to-be-evaluated location and the second to-be-evaluated location according to the target truth value data on user behaviors; and
evaluating the at least one to-be-evaluated route according to the target reference route.

18. The non-transitory computer-readable storage medium of claim 17, wherein acquiring the target truth value data on user behaviors between the first to-be-evaluated location and the second to-be-evaluated location and collected by the route planning client comprises:
at least one of: acquiring truth value data on user behaviors uploaded by the route planning client in real time, or acquiring user feedback truth value data uploaded by an evaluation-assisting user-side through the route planning client; and
screening at least one of the truth value data on user behaviors or the user feedback truth value data according to the first to-be-evaluated location and the second to-be-evaluated location to obtain the target truth value data on user behaviors.

19. The non-transitory computer-readable storage medium of claim 18, wherein the at least one to-be-evaluated route is a route planned for a public transport vehicle;
wherein screening the truth value data on user behaviors according to the first to-be-evaluated location and the second to-be-evaluated location comprises:
determining to-be-evaluated truth value data on user behaviors between the first to-be-evaluated location and the second to-be-evaluated location according to the truth value data on user behaviors; and
in response to determining that the to-be-evaluated truth value data on user behaviors comprises truth value data on group user behaviors, using the truth value data on group user behaviors as the target truth value data on user behaviors.

20. The non-transitory computer-readable storage medium of claim 19, wherein determining that the to-be-evaluated truth value data on user behaviors comprises the truth value data on group user behaviors comprises:
acquiring a user movement time, a user movement route and a user pause location comprised in the to-be-evaluated truth value data on user behaviors;
determining target to-be-evaluated truth value data on user behaviors where the user movement route matches a planned travel route and the user pause location matches a planned parking location within a same user movement time;
counting a number of pieces of target truth value data according to the target to-be-evaluated truth value data on user behaviors; and
in response to determining that the number of pieces of target truth value data is greater than or equal to a preset user number threshold, determining the target to-be-evaluated truth value data on user behaviors with the number of pieces of target truth value data to be the truth value data on group user behaviors.
